(19) United States
(12) Patent Application Publication
(10) Pub. No.: US 2022/0115692 A1
(43) Pub. Date: Apr. 14, 2022

(54) DYNAMICALLY-BONDED SUPRAMOLECULAR POLYMERS FOR STRETCHABLE BATTERIES

(71) Applicant: The Board of Trustees of the Leland Stanford Junior University, Stanford, CA (US)

(72) Inventors: David George Mackanic, Stanford, CA (US); Xuzhou Yan, Stanford, CA (US); Yi Cui, Stanford, CA (US); Zhenan Bao, Stanford, CA (US)

(73) Assignee: The Board of Trustees of the Leland Stanford Junior University, Stanford, CA (US)

(21) Appl. No.: 17/423,712

(22) PCT Filed: Jan. 17, 2020
(86) PCT No.: PCT/US2020/014071

§ 371 Date: Jul. 16, 2021

Related U.S. Application Data
(60) Provisional application No. 62/794,481, filed on Jan. 18, 2019.

(51) Int. Cl. H01M 10/0565; H01M 4/04; H01M 4/62

(52) U.S. Cl. CPC H01M 10/0565; H01M 4/0407; H01M 2300/0085; H01M 2300/0082; H01M 4/624

(57) ABSTRACT

A battery includes: 1) an anode; 2) a cathode; and 3) a solid or gel electrolyte disposed between the anode and the cathode, wherein the electrolyte includes a supramolecular polymer formed of, or including, molecules crosslinked through dynamic bonds, and each of the molecules includes an ionic ally conductive domain.

### CROSS-REFERENCE TO RELATED APPLICATIONS

This application claims the benefit of U.S. Provisional Application No. 62/794,481, filed Jan. 18, 2019, the contents of which are incorporated herein by reference in their entirety.

### TECHNICAL FIELD

This disclosure generally relates to a stretchable battery.

### BACKGROUND

Recent technological advances and the continual miniaturization of electronics have diminished the divide between humans and technology. Increasingly, humans are in close contact with electronic devices in the form of personal computers, portable smartphones, and wearable electronics. These electronics are typically stiff, and do not conform to the human body. Looking to the future, there is substantial interest in developing electronics that are more intimate with the human body. Such applications include human-facing soft robotics, sensors that conform to human skin, and electronic devices that can be implanted directly into human tissue. Recent advances in stretchable electronics have facilitated these applications; from strain-engineered rigid-island structures to intrinsically stretchable semiconducting polymers and circuits, soft electronics are rapidly becoming a reality. However, there is a substantial constraint for the development of soft and stretchable electronics due to the lack of an adequate, portable power source. While some flexible battery materials have been proposed, there is still a substantial gap in the ability to fabricate stretchable battery materials to fabricate electronics that intimately couple to the human body.

To address the demand for stretchable batteries, several approaches have been proposed. Strategies for stretchable batteries include strain-engineering rigid electrodes to conform to applied strain either through interconnected rigid-islands, formation of a buckled electrode structure, or wrapping active materials around a stretchable cylindrical rod. While these strategies show promise for stretchable forms of energy storage, their intensive fabrication processes are at substantial economic odds with the low-cost slurry process used to form commercial battery materials. Other approaches to fabricating stretchable batteries involve using composite mixtures of active materials and elastomer molecules to create intrinsically stretchable battery materials. While this approach shows promise from an economic standpoint, the elastomers used to make intrinsically stretchable battery materials generally are not ionically conductive, specifying that these stretchable batteries use liquid electrolytes in their operation.

There are safety hazards associated with using liquid electrolytes in lithium-ion batteries. For a stretchable battery application in intimate contact with the human body, the safety hazards associated with electrolyte leakage and flammability are exacerbated. Desirably, stretchable battery materials would utilize a solid polymer electrolyte. However, a stretchable polymer electrolyte with sufficient ionic conductivity for battery operation has not been reported. The use of gel electrolytes is a desirable compromise for stretchable batteries with sufficient ionic conductivity. While stretchable gel electrolytes have been reported, these gel-electrolytes typically have poor mechanical properties, and thus could lead to shorting when used in a stretchable battery.

It is against this background that a need arose to develop embodiments of this disclosure.

### SUMMARY

Stretchable batteries are desired for applications in which soft electronics interface directly with the human body. However, other approaches for stretchable batteries rely on costly strain-engineering approaches. Herein, some embodiments are directed to a supramolecular polymeric design to fabricate a stretchable lithium ion conductor (SLIC). SLIC utilizes orthogonally functional hydrogen bonding domains and ionically conductive domains to create an ultra-resilient polymer electrolyte with high ionic conductivity. Implementation of SLIC as a binder material allows for the formation of stretchable Li-ion battery electrodes via a slurry process. Combining the SLIC-based electrolytes and electrodes allows the fabrication of an all-stretchable battery with excellent performance even when deformed or stretched to about 70% of its original length.

Advantages of some embodiments of this disclosure include: 1) decoupling of mechanical properties from ionic conductivity, which allows for a highly resilient lithium-ion battery electrolyte that also has excellent ionic conductivity; 2) excellent mechanical properties allows for the creation of intrinsically stretchable electrodes, which can achieve higher mass loading at a much lower cost; and 3) dynamic bonding allows for the formation of continuous interface and so a liquid electrolyte can be omitted.

A stretchable lithium ion conductor has applications in stretchable batteries, supercapacitors, fuel cells, and other electrochemical energy storage devices. Applications for stretchable batteries include use in soft robotics, wearable electronics, and implanted electronic devices.

In some embodiments, a battery includes: 1) an anode; 2) a cathode; and 3) a solid or gel electrolyte disposed between the anode and the cathode, wherein the electrolyte includes a supramolecular polymer formed of, or including, molecules crosslinked through dynamic bonds, and each of the molecules includes an ionically conductive domain.

In additional embodiments, an electrode includes: 1) an active electrode material; 2) conductive fillers; and 3) a supramolecular polymer formed of, or including, molecules crosslinked through dynamic bonds, each of the molecules includes an ionically conductive domain, and the active electrode material and the conductive fillers are dispersed in the supramolecular polymer.

In further embodiments, a battery includes the electrode of any of the foregoing embodiments.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Schematic of stretchable lithium ion conductor (SLIC) macromolecules. (A) Chemical structure of SLIC and the composition and molecular weight of SLIC 0-3. (B) Diagram showing the operating principle of the SLIC-based polymer electrolyte. (C) Diagram of the use of SLIC-based electrolytes and electrodes to create an all-integrated stretchable battery with a seamless interface.

FIG. 2. Characterization of SLIC macromolecules. (A) stress-strain curves of SLIC 0-3 at an extension rate of about 50 mm/min. (D) Time-temperature superposition rheology of SLIC 0-3. (E) Differential scanning calorimetry (DSC) Traces of SLICs. The substantially constant T_{g} at about −49° C. is indicated. (C) Small-angle X-ray scattering (SAXS) of SLICs. (B) Strain cycling of SLIC-3 at a rate of about 30 mm/min. SLIC-3 is stretched to about 300%, and then stretched again immediately. After relaxing for about 1 hour, the third stretch is performed.

FIG. 3. Characterization of SLIC as a polymer electrolyte. All samples include about 20% lithium bis(trifluoromethanesulfonyl)imide (LiTFSI) unless otherwise indicated. (A) Ionic conductivity of plasticized and neat SLIC electrolytes as a function of amount of 2-ureido-4-pyrimidone (UPy) in the backbone. (B) Electrochemical impedance spectroscopy (EIS) traces for unplasticized SLIC electrolytes. (C) Ionic conductivity versus T_{g} shifted temperature for plasticized SLIC electrolytes. The dashed line serves to guide the eye. (D) SAXS spectra of SLIC-3 polymer with 0 and about 20% LiTFSI. (E) Cyclic stress-strain curve of the SLIC electrolyte with and without about 2% SiO₂. (F) Stress-strain curves of plasticized SLIC-3 electrolytes with and without about 2% SiO₂. (G) Temperature-dependent ionic conductivity of SLIC-3 electrolytes with different additives. (H) Normalized ionic conductivity as a function of strain for the SLIC electrolyte. (I) Comparison of the modulus of resilience (Uᵣ) and ionic conductivity of SLIC electrolytes to other reported electrolytes.

FIG. 4. Use of SLIC to form stretchable electrode materials. (A) stress-strain curves of mixtures of SLIC-1 based electrodes with different amounts of carbon black and lithium iron phosphate (LFP). (B) Comparison of composite electrode stretchability with different polymer component. (C) Adhesion energy between a SLIC-3 electrolyte and various composite electrodes. (D) SEM image of the interface between SLIC-3 electrolyte and a 7:2:1 SLIC-1 based electrode. (E) Charge-discharge traces at various rates of a battery including a lithium anode, SLIC-3 electrolyte, and SLIC-1 composite cathode. (F) Capacity versus cycle number for the battery in E. (G) Long-term cycling of a battery with the same components as in (E). (H) Charge-discharge curves at different cycle numbers for the battery in (G).

FIG. 5. Stretchable batteries based on SLIC. (A) Schematic of an all-SLIC stretchable battery. (B) Change in resistance of the Au@SLIC current collector as a function of strain. (C) Stress-strain curves of the Au@SLIC current collector with and without the SLIC-1 electrode coating. (D) Capacity versus cycle number for a full-cell based on stretchable SLIC components. The active material loading is about 1.1 mAh cm⁻². (E) Charge-discharge curve of the battery in (D) at cycle 1 and 40. The rate is C/10. (F) Performance of an all-SLIC stretchable battery under 0 and about 60% strain. (G) Demonstration of a stretchable SLIC battery providing power to a red light-emitting diode (LED) under no strain, stretched about 70%, folded, and returned to its original position.

FIG. 6. Effect of salt loading on the mechanical properties of the SLIC-1 based electrolyte. Initially, addition of LiTFSI increases the mechanical properties because ionic crosslinking is dominant. This is different than what is observed in SLIC-3, where LiTFSI primarily causes a decrease in the mechanical properties. This difference is because SLIC-1 does not have a substantial number of crosslinks to begin with, so addition of LiTFSI creates additional crosslinks that enhance the strength.

FIG. 7. Effect of di(ethylene glycol)dimethyl ether (DEGDME) content on ionic conductivity. About 30% DEGDME does not provide significant improvement over about 20% DEGDME.

FIG. 8. (A) Ionic conductivity of SLIC-3 based electrolytes as a function of LiTFSI concentration with and without about 20% DEGDME plasticizer. (B) Glass transition temperature of SLIC-3 based electrolytes as a function of LiTFSI concentration with and without about 20% DEGDME plasticizer. For both samples, the measured ionic conductivity correlates with changes in the glass transition temperature. Initially, increased salt causes increased ionic crosslinking up until about 40% LiTFSI, increasing the T_{g} and lowering ionic conductivity. Above about 40% LiTFSI, the plasticizing effect of the TFSI anion becomes dominant, leading to a lowered T_{g} and enhanced ionic conductivity. This correlates well to the sharp drop in mechanical properties that is observed above about 40 wt. % LiTFSI. For the plasticized samples, these effects are less noticeable because the primary mechanism for ionic conductivity is through partially solvated Lit

FIG. 9. T_{g} of the different SLIC films with about 20% LiTFSI and plasticizer. The addition of about 20% LiTFSI causes a drastic increase in the T_{g}, which is then lowered by the addition of the DEGDME plasticizer. As UPy concentration increases, the T_{g} of the plasticized sample becomes progressively lower. This is potentially caused by interaction of the UPy groups with the DEGDME.

FIG. 10. Stress-strain measurements of SLIC 0-3 with about 20% LiTFSI.

FIG. 11. (A) Cyclic stress-strain curves of SLIC-3 with about 20% LiTFSI. The elasticity is retained in the presence of LiTFSI. (B) Including about 2% SiO₂ also has yields better cyclability.

FIG. 12. Cyclic stress-strain curves of SLIC-3 with about 20% LiTFSI and about 20% DEGDME and about 2% SiO₂. 5 cycles each at about 30%, about 60%, and about 1% at a rate of about 30 mm/min.

FIG. 13. ⁷Li NMR shift for various SLIC samples and a polyethylene oxide (PEO) reference. All samples include about 20 wt. % LiTFSI. Plasticized samples include an additional about 20 wt. % DEGDME. All experiments are carried out in deuterated chloroform, which does not solvate LiTFSI and thus should not affect the coordination environment. The lithium coordination environment does not change drastically for any of the SLIC samples.

FIG. 14. Temperature-dependent ionic conductivity of SLIC samples with about 20 wt. % LiTFSI and about 20 wt. % DEGDME. The temperature-dependent ionic conductivity is normalized to the T_{g} of each polymer. It can be seen that the conductivities nearly fall exactly along a master curve. The dashed line serves to guide the eye.

FIG. 15. Electrochemical stability and transference number measurement of SLIC-3 based electrolyte including about 20% LiTFSI+about 20% DEGDME+about 2% SiO₂. The measurements were carried out at about 37° C., and the measured transference number is about 0.43.

FIG. 16. EIS traces as a function of strain for the SLIC-3 based electrolyte, normalized to the resistance of an unstrained sample. The slight decrease in conductivity observed is due to the sample thickness becoming thinner as the stretching increases.

FIG. 17. Adhesion energy of SLIC-3 and other polymers.

FIG. 18. Cyclic voltammetry curve of a Li|SLIC|LFP/SLIC/carbon black (CB) electrode at a rate of about 0.25 mV/s. Very little degradation is observed over the progression of the cycles.

FIG. 19. Charge-discharge curves of SLIC-based LFP|| lithium titanate (LTO) full cell with all stretchable battery components. The mass loading is about 1.1 mAh cm⁻².

FIG. 20. Battery performance of SLIC-based electrode in the presence of liquid electrolyte showing high rate-capability and good cycling stability.

FIG. 21. Battery according to some embodiments.

FIG. 22. Electrode according to some embodiments.

### DESCRIPTION

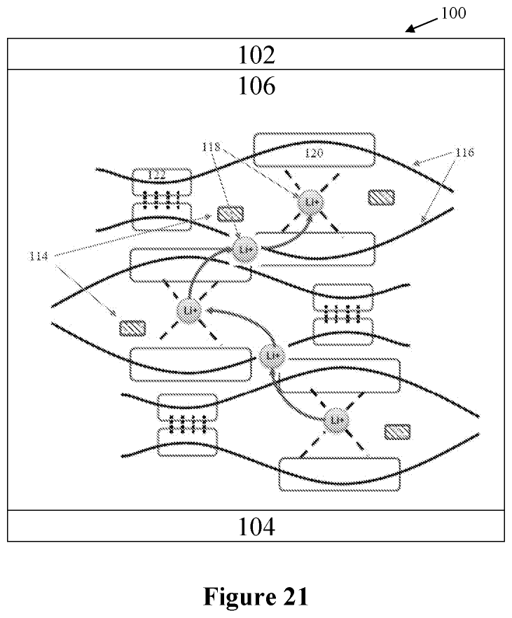

FIG. 21 illustrates a battery 100 according to some embodiments. As illustrated, the battery 100 includes: 1) an anode 102; 2) a cathode 104; and 3) a solid or gel electrolyte 106 disposed between the anode 102 and the cathode 104, wherein the electrolyte 106 includes a supramolecular polymer 116 formed of, or including, molecules crosslinked through dynamic bonds, and each of the molecules includes an ionically conductive domain 120.

In some embodiments of the battery 100, the dynamic bonds include hydrogen bonds. Other types of reversible (or dynamic), relatively weak bonds, such as coordination bonds (e.g., metal-ligand bonds) or electrostatic interactions, can be included in addition to, or in place of, hydrogen bonds. In some embodiments, each of the molecules includes a hydrogen bonding domain 122. In some embodiments, the hydrogen bonding domain 122 includes an oxygen-containing functional group, a nitrogen-containing functional groups, or both. In some embodiments, the hydrogen bonding domain 122 includes one or more of hydroxyl, amine, and carbonyl-containing functional groups. In some embodiments, the hydrogen bonding domain 122 can include a carbonyl-containing functional group. Carbonyl-containing functional groups include the moiety C═O. Examples of carbonyl-containing functional groups include amide, ester, urea, 2-ureido-4-pyrimidone, and carboxylic acid functional groups. In some embodiments, the hydrogen bonding domain 122 can include a nitrogen-containing functional group, such as selected from amine, amide, urea, and 2-ureido-4-pyrimidone. Amine, amide, urea, and 2-ureido-4-pyrimidone include the moiety —NHR, where R can be hydrogen or a moiety different from hydrogen. Certain functional groups, such as amide, urea, and ureidopyrimidone, include both the C═0 moiety as well as the —NHR moiety.

In some embodiments of the battery 100, the ionically conductive domain 120 includes a polyalkylene oxide chain. In some embodiments, the polyalkylene oxide chain is in the form of (—O—A)ₙ— where n is an integer that is 2 or greater, and A is an alkylene, such as ethylene or propylene. In some embodiments, the polyalkylene oxide chain is in the form of (—O—A1)ₙ₁(—O—A2)ₙ₂— where n1 is an integer that is 1 or greater, n2 is an integer that is 1 or greater, and A1 and A2 are different alkylenes, such as selected from ethylene and propylene. In some embodiments, the polyalkylene oxide chain is in the form of (—O—A1)ₙ₁(—O—A2)ₙ₂(—O—A1)ₙ₃— where n1 is an integer that is 1 or greater, n2 is an integer that is 1 or greater, n3 is an integer that is 1 or greater, and A1 and A2 are different alkylenes, such as selected from ethylene and propylene. Other ionically conductive domains, such as polyethylenimine chains, polyacrylonitrile chains, polyethylene carbonate chains, or perfluoropolyether chains, can be included in addition to, or in place of, polyalkylene oxide chains.

In some embodiments of the battery 100, the electrolyte 106 further includes lithium cations 118 dispersed in the supramolecular polymer 116. Other types of metal cations, such as sodium cations, can be included in addition to, or in place of, lithium cations. In some embodiments, a concentration of the metal ions (e.g., lithium ions 118) can be at least about 0.01% by weight relative to a total weight of the electrolyte 106, such as at least about 0.03% by weight, at least about 0.05% by weight, at least about 0.08% by weight, at least about 0.1% by weight, at least about 0.2% by weight, at least about 0.3% by weight, or at least about 0.4% by weight, and up to about 0.5% by weight or greater, up to about 0.7% by weight or greater, up to about 1% by weight or greater, or up to about 1.5% by weight or greater.

In some embodiments of the battery 100, the electrolyte 106 further includes fillers 114 dispersed in the supramolecular polymer 116. In some embodiments, the fillers 114 include ceramic fillers. In some embodiments, a concentration of the fillers 114 can be at least about 0.1% by weight relative to a total weight of the electrolyte 106, such as at least about 0.3% by weight, at least about 0.5% by weight, at least about 0.8% by weight, at least about 1% by weight, or at least about 2% by weight, and up to about 3% by weight or greater, or up to about 4% by weight or greater.

In some embodiments of the battery 100, the supramolecular polymer has a glass transition temperature that is no greater than about 25° C., such as from about −100° C. to about 25° C., from about −100° C. to about 0° C., from about −100° C. to about −25° C., from about −50° C. to about 25° C., from about −50° C. to about 0° C., or from about 0° C. to about 25° C.

In some embodiments of the battery 100, the electrolyte 106 has an ionic conductivity of at least about 10⁻⁶ S/cm at room temperature (25° C.), such as at least about 3×10⁻⁶ S/cm, at least about 5×10⁻⁶ S/cm, at least about 8×10⁻⁶ S/cm, at least about 10⁻⁵ S/cm, at least about 3×10⁻⁵ S/cm, at least about 5×10⁻⁵ S/cm, at least about 8×10⁻⁵ S/cm, or at least about 10⁻⁴ S/cm, and up to about 10⁻³ S/cm or greater.

In some embodiments of the battery 100, the electrolyte 106 has an ultimate tensile stress of at least about 0.1 MPa, such as at least about 0.5 MPa, at least about 1 MPa, at least about 1.5 MPa, at least about 2 MPa, or at least about 2.5 MPa, and up to about 3 MPa or greater, or up to about 4 MPa or greater. In some embodiments, the electrolyte 106 has an extensibility (or percentage elongation-at-break) of at least about 30%, at least about 40%, at least about 50%, at least about 60%, at least about 70%, at least about 80%, at least about 90%, at least about 100%, at least about 200%, at least about 300%, at least about 400%, at least about 500%, at least about 1,000%, at least about 1,500%, or at least about 2,000%, and up to about 2,500% or greater.

In some embodiments of the battery 100, at least one of the anode 102 or the cathode 104 includes a supramolecular polymer having the foregoing characteristics specified for the electrolyte 106. In some embodiments, the anode 102 includes a supramolecular polymer, along with an active anode material and conductive fillers dispersed in the supramolecular polymer. In some embodiments, the cathode 104 includes a supramolecular polymer, along with an active cathode material and conductive fillers dispersed in the supramolecular polymer. In some embodiments, the conductive fillers include carbonaceous fillers.

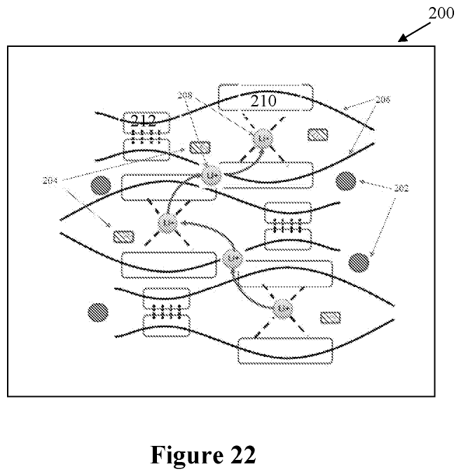

FIG. 22 illustrates an electrode 200 according to additional embodiments. As illustrated, the electrode 200 includes: 1) an active electrode material 202; 2) conductive fillers 204; and 3) a supramolecular polymer 206 formed of, or including, molecules crosslinked through dynamic bonds, each of the molecules includes an ionically conductive domain 210, and the active electrode material 202 and the conductive fillers 204 are dispersed in the supramolecular polymer 206.

In some embodiments of the electrode 200, the dynamic bonds include hydrogen bonds. Other types of reversible (or dynamic), relatively weak bonds, such as coordination bonds (e.g., metal-ligand bonds) or electrostatic interactions, can be included in addition to, or in place of, hydrogen bonds. In some embodiments, each of the molecules includes a hydrogen bonding domain 212. In some embodiments, the hydrogen bonding domain 212 includes an oxygen-containing functional group, a nitrogen-containing functional groups, or both. In some embodiments, the hydrogen bonding domain 212 includes one or more of hydroxyl, amine, and carbonyl-containing functional groups. In some embodiments, the hydrogen bonding domain 212 can include a carbonyl-containing functional group. Carbonyl-containing functional groups include the moiety C═O. Examples of carbonyl-containing functional groups include amide, ester, urea, 2-ureido-4-pyrimidone, and carboxylic acid functional groups. In some embodiments, the hydrogen bonding domain 212 can include a nitrogen-containing functional group, such as selected from amine, amide, urea, and 2-ureido-4-pyrimidone. Amine, amide, urea, and 2-ureido-4-pyrimidone include the moiety —NHR, where R can be hydrogen or a moiety different from hydrogen. Certain functional groups, such as amide, urea, and ureidopyrimidone, include both the C═O moiety as well as the —NHR moiety.

In some embodiments of the electrode 200, the ionically conductive domain 210 includes a polyalkylene oxide chain. In some embodiments, the polyalkylene oxide chain is in the form of (—O—A)ₙ— where n is an integer that is 2 or greater, and A is an alkylene, such as ethylene or propylene. In some embodiments, the polyalkylene oxide chain is in the form of (—O—A1)ₙ₁(—O—A2)ₙ₂— where n1 is an integer that is 1 or greater, n2 is an integer that is 1 or greater, and A1 and A2 are different alkylenes, such as selected from ethylene and propylene. In some embodiments, the polyalkylene oxide chain is in the form of (—O—A1)ₙ₁(—O—A2)ₙ₂(—O—A1)ₙ₃— where n1 is an integer that is 1 or greater, n2 is an integer that is 1 or greater, n3 is an integer that is 1 or greater, and A1 and A2 are different alkylenes, such as selected from ethylene and propylene. Other ionically conductive domains, such as polyethylenimine chains, polyacrylonitrile chains, polyethylene carbonate chains, or perfluoropolyether chains, can be included in addition to, or in place of, polyalkylene oxide chains.

In some embodiments of the electrode 200, the electrode 200 further includes lithium cations 208 dispersed in the supramolecular polymer 206. Other types of metal cations, such as sodium cations, can be included in addition to, or in place of, lithium cations. In some embodiments, a concentration of the metal cations (e.g., lithium ions 208) can be at least about 0.01% by weight relative to a total weight of the electrode 200, such as at least about 0.03% by weight, at least about 0.05% by weight, at least about 0.08% by weight, at least about 0.1% by weight, at least about 0.2% by weight, at least about 0.3% by weight, or at least about 0.4% by weight, and up to about 0.5% by weight or greater, or up to about 0.7% by weight or greater.

In some embodiments of the electrode 200, the electrode 200 has an ionic conductivity of at least about 10⁻⁶ S/cm at room temperature (25° C.), such as at least about 3×10⁻⁶ S/cm, at least about 5×10⁻⁶ S/cm, at least about 8×10⁻⁶ S/cm, at least about 10⁻⁵ S/cm, at least about 3×10⁻⁵ S/cm, at least about 5×10⁻⁵ S/cm, at least about 8×10⁻⁵ S/cm, or at least about 10⁻⁴ S/cm, and up to about 10⁻³ S/cm or greater.

In some embodiments of the electrode 200, the electrode 200 has an ultimate tensile stress of at least about 0.1 MPa, such as at least about 0.5 MPa, at least about 1 MPa, at least about 1.5 MPa, at least about 2 MPa, or at least about 2.5 MPa, and up to about 3 MPa or greater, or up to about 4 MPa or greater. In some embodiments, the electrode 200 has an extensibility (or percentage elongation-at-break) of at least about 30%, at least about 40%, at least about 50%, at least about 60%, at least about 70%, at least about 80%, at least about 90%, at least about 100%, at least about 200%, at least about 300%, at least about 400%, at least about 500%, or at least about 900%, and up to about 1,500% or greater.

In further embodiments, a battery includes the electrode 200 of any of the foregoing embodiments.

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

### Overview

In this example, supramolecular polymer engineering is introduced to form gel polymer electrolytes with excellent mechanical properties. By embedding hydrogen bonding 2-ureido-4-pyrimidone (UPy) moieties into an ionically conductive polymer backbone, an ultra-resilient polymer electrolyte is formed that has mechanical properties that are decoupled from the ionic conductivity. This polymer, called a stretchable lithium ion conductor (SLIC), can be used as a resilient polymer electrolyte and has an ionic conductivity of about 2×10⁻⁴ S cm⁻¹ when gelled with a moderate amount (e.g., about 20 wt. %) of a plasticizer. The extreme resilience of this polymer electrolyte allows for the fabrication of intrinsically stretchable battery materials that do not involve strain engineering or liquid electrolyte. Furthermore, the dynamic hydrogen bonding of this polymer allows for the formation of excellent interfaces between an electrode and electrolyte components. These interfaces allow for the formation of stretchable lithium-ion batteries with continuous ion transport between various components. The strategy reported here of using supramolecular dynamic bonding to form stretchable ion conductors opens a new pathway for fabricating strong, resilient materials for stretchable lithium-ion batteries.

### Results

### Characterization of Supramolecular SLIC Polymers

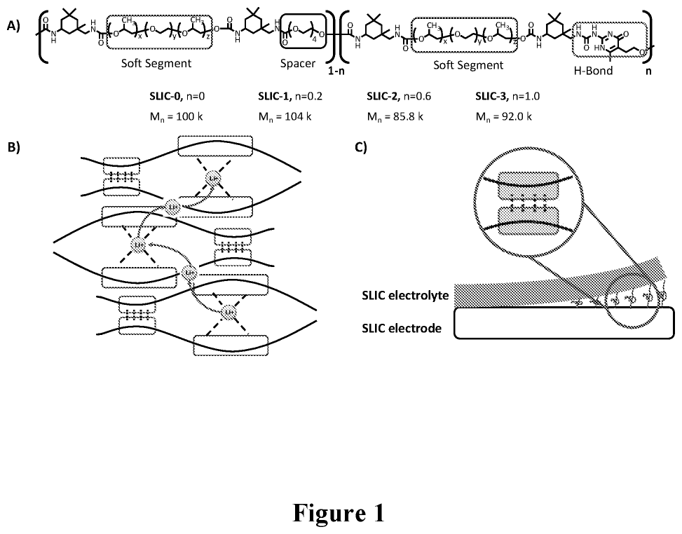

FIG. 1A shows a schematic of synthesized SLIC macromolecules. SLIC molecules were synthesized through via condensation of hydroxyl terminated macromonomers and diisocyanate linkers. The SLIC macromolecule is composed of three major building blocks. The first is a soft segment, which is based on the ion conducting polymer polypropylene glycol-polyethylene glycol-polypropylene glycol (PPG-PEG-PPG). The molecular weight of the soft segment is about 2900 kDa. A hydrogen-bonding motif 2-ureido-4-pyrimidone (UPy) is included in the backbone to impart mechanical strength to the polymer. Finally, when the hydrogen bonding segment is not included, an aliphatic extender or spacer is included instead. To systematically investigate the effect of the hydrogen bonding UPy moiety on the mechanical properties and ion transport properties of the macromolecules, a series of polymers denoted SLIC-0, SLIC-1, SLIC-2, and SLIC-3 were synthesized. SLIC-0 contains 0% hydrogen bonding units in the backbone, whereas SLIC-3 contains 100% UPy and no aliphatic extenders. The molecular weights of the synthesized SLICs are about 100 kDa as determined by gel permeation chromatography (GPC). ¹H NMR confirms successful synthesis of the SLIC molecules. It is noted that by systematically varying the ratios of UPy to extender, the total amount of soft segment is the same for all SLICs. FIG. 1B shows a schematic of the operating principle of the SLIC macromolecules. In SLIC, lithium ions are transported through the PPG-PEG-PPG soft segment, which makes up the majority of the polymer. The UPy moieties in the polymer backbone interact with each other independently of the soft segment, creating regions with high mechanical strength. The inclusion of hydrogen bonding moieties into the backbone of the polymer also has advantages for the fabrication of fully stretchable battery components, such as stretchable electrodes. For example, in FIG. 1C, the strong interaction between a SLIC-based electrode and a SLIC-based electrolyte are shown, where the segmental relaxation of the polymer backbone allows for dynamic hydrogen bonding to occur at an electrode-electrolyte interface, creating a seamlessly integrated stretchable battery.

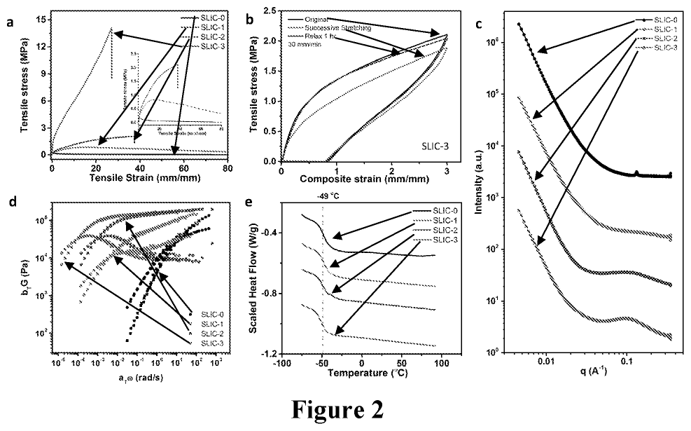

The mechanical properties of the as-synthesized SLIC molecules are of importance when assessing the feasibility of the polymer for use as a robust stretchable electrolyte. FIG. 2A shows stress-strain curves of SLIC-0 through 3. For SLIC-0, the tensile stress in the sample is extremely low, and the polymer yields at low strain. As the amount of UPy in the backbone increases, the tensile stress to stretch the elastomers increases systematically. Increasing the amount of UPy also enhances the elastic behavior of the polymers, although the overall extensibility lowers. For SLIC-3, an impressive extensibility of about 2,400% and an ultimate stress of about 14 MPa is obtained. The elastic behavior of SLIC-3 is shown in FIG. 2B. While the dynamic nature of the hydrogen bonding crosslinks imparts viscoelastic behavior to the polymers, the SLIC-3 polymer shows excellent stress recovery at low strains upon successive cycling. After resting for about 1 hour, the polymer completely recovers its original mechanical properties. The cyclic stress-strain curves for SLIC-0,1,2 are shown in Supporting Information. While these polymers are also viscoelastic, they demonstrate lower stress recovery than SLIC-3. As observed, the ability to recover from strain increases as the amount of hydrogen bonding in the network increases. To investigate the microstructure of the SLIC polymers, small-angle X-ray scattering (SAXS) measurements were performed (FIG. 2C). As the UPy content of the polymer increases from SLIC-0 to SLIC-3, a broad peak with d-spacing of about 6 nm becomes more prominent. This peak shows the presence of phase-separated hydrogen bonding domains that give the polymer excellent mechanical properties. The broadness of this peak indicates that the population of the UPy domains is low, as expected based on the molecular structure of SLIC.

FIG. 2D shows the rheological properties of SLIC 0-3. Time-temperature superposition rheometry is used to obtain data for the shear modulus of the SLIC molecules from 10⁻⁵ to 10³ rad s⁻¹. From the rheology, it can be observed that the modulus for the rubbery plateau is similar for all of the SLICs. The crossover point between the loss and storage modulus is the location at which the polymer undergoes a transition from being “liquid-like” to being “solid-like.” This transition point also provides an indication of the crosslinking density in the sample. Transitions that occur at higher frequencies indicate that the crosslinking density between chains is lower, and so the molecule relaxes more quickly. FIG. 2D shows that as the amount of UPy in the polymer backbone increases from SLIC 0-3, the polymer relaxation time becomes slower, which is consistent with the increased crosslinking density that is expected from the UPy hydrogen bonding. This also means that at short time scales, SLIC-0 will relax and flow more than SLIC-3. FIG. 2E shows differential scanning calorimetry (DSC) traces for SLIC 0-3. All of the SLICs show a glass transition temperature (T_{g}) at about −49° C. This T_{g} arises from the relaxation of the soft PPG-PEG-PPG segment in the polymer backbone. That a substantially constant T_{g} is observed for all of the different SLICs is important when considering application as a polymer electrolyte. Overall, the supramolecular design of the SLIC system gives excellent control over the mechanical properties of the polymer system.

### SLIC as a Polymer Electrolyte

One of the major advantages of the SLIC system for use as a polymer electrolyte is the decoupling of the T_{g} from the mechanical properties of the polymer through the use of orthogonally functional hydrogen bonding and ion conducting domains. The Vogel-Tamman-Fulcher (VTF) equation dictates that a lower T_{g} in a polymer electrolyte leads to higher ionic conductivity. As such, efforts for polymer electrolyte have focused on reducing the T_{g} of polymer electrolytes in order to improve ionic conductivity. However, lowering the T_{g} of a polymer can be deleterious to the strength of a polymer, and so a polymer electrolyte with a low T_{g} can lead to hazards such as short circuiting via external puncture or from dendrite formation. For stretchable batteries, the dangers of short-circuit due to soft and weak polymer electrolytes are exacerbated when the battery is stretched. Because of these dangers, polymer engineering strategies have been developed to overcome the trade-off between T_{g} and mechanical strength of a polymer electrolyte. One strategy is based on a polystyrene (PS)-polyethylene oxide (PEO) block copolymer, in which the PS block provides mechanical strength and the PEO block provides ionic conductivity. Other strategies include nanoscale-phase separation, crosslinking with hairy nanoparticles, and addition of ceramic fillers. However, these strategies result in rigid electrolytes, and thus are not suitable for application as stretchable polymer electrolytes. Herein, the SLIC system provides a strategy based on supramolecular engineering to decouple the ionic conductivity from the mechanical strength of a polymer electrolyte.

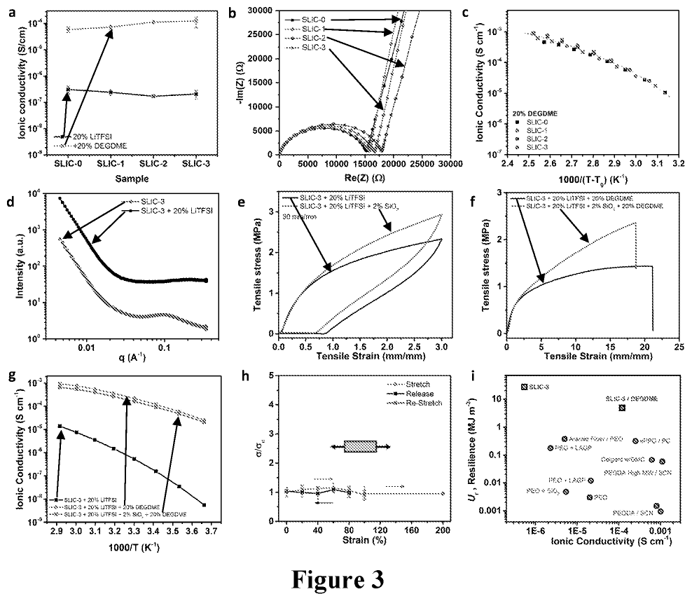

To confirm this hypothesis, polymer electrolytes were created by dissolving a lithium salt (lithium bis(trifluoromethanesulfonyl)imide (LiTFSI)) into the polymer and casting a film. Ion transport properties were investigated with and without the presence of di(ethylene glycol)dimethyl ether (DEGDME) as a plasticizer. Experimentally, about 20 wt. % LiTFSI and about 20 wt. % DEGDME were chosen in the formation of polymer electrolyte films to enhance the ionic conductivity and mechanical properties of the samples. FIG. 3A shows that the ionic conductivity for the SLIC polymer electrolytes remains relatively constant as the amount of hydrogen bonding, and thus the mechanical properties, increases from SLIC-0 to SLIC-3. This observation is true for both the plasticized and unplasticized samples. Notably, the SLIC samples with about 20% LiTFSI and about 20% DEGDME have a high ionic conductivity value of about 1×10⁻⁴ S cm⁻¹ at room temperature. The similarity between the ionic conductivities of the SLIC samples indicates that the soft PPG-PEG-PPG segment dictates the ionic conductivity, and that the conductivity is orthogonal to the hydrogen bonding UPy moieties. To support this, FIG. 3B shows that the electrochemical impedance spectroscopy (EIS) traces for the unplasticized SLIC samples all look nearly identical. Furthermore, for the plasticized SLIC polymer electrolytes, the T_{g} normalized temperature-dependent ionic conductivity falls along a single master curve, indicating that the ion transport mechanism is similar (FIG. 3C). Furthermore, the VTF activation energies of all the SLIC samples are within about 1 kJ mol⁻¹ of one another. A final piece of evidence that the soft segment dictates the conductivity of the SLIC samples comes from ⁷Li NMR. ⁷Li NMR shows that the lithium solvation environment in all of the SLIC-LiTFSI-DEGDME complexes is relatively constant, confirming that the UPy moieties do not interfere with the lithium conductivity. With these data, SLIC-3 is chosen as a polymer electrolyte because of its extreme robustness and high ionic conductivity.

The mechanical properties of the SLIC-based polymer electrolytes can determine their performance as a solid electrolyte. Addition of LiTSFI salt causes a decrease in the mechanical properties of the SLIC based electrolytes. This is potentially due to the Li⁺ driven ionic crosslinking of the soft segments or the plasticizing TFSI anion interfering with the formation of the UPy domains. Indeed, FIG. 3D shows a decrease in the 6 nm SAXS peak attributed to the UPy domains. However, FIG. 3D shows that the overall morphology remains substantially constant. In order to combat the negative effects of LiTFSI addition on the mechanical properties of the electrolyte, about 2 wt. % silica (SiO₂) was added to the polymer electrolyte. Small amounts of ceramic additive can have several benefits including increasing the mechanical properties and enhancing the lithium transference number. FIG. 3E shows that while the SLIC-3 based electrolyte with about 20% LiTFSI has good mechanical properties, the addition of about 2% SiO₂ can increase them further and also improve the elasticity of the samples. Finally, the effect of the plasticizer is considered. When about 20% DEGDME plasticizer is added, the mechanical properties of the electrolyte drop notably. However, as shown in FIG. 3F, addition of about 2% SiO₂ restores some of the original mechanical properties and the polymer remains elastic. Even with the addition of LiTFI and DEGDME, the SLIC-3 based polymer electrolyte retains a high ultimate stress of about 2.5 MPa and an extensibility of about 2000%. The effect of the addition of LiTFSI, DEGDME, and SiO₂ on the ionic conductivity of the SLIC-3 based electrolytes is shown in FIG. 3G. The addition of about 20% DEGDME results in a notable increase in ionic conductivity, while the addition of about 2% SiO₂ causes a modest decrease in the ionic conductivity. The final choice for the high-performance polymer electrolyte is SLIC-3 with about 20% LiTFSI, about 20% DEGDME, and about 2% SiO₂. It is confirmed that this electrolyte has no deleterious side reactions in a Li||SS electrochemical cell and has a respectable lithium transference number of about 0.43. The following sections will refer to this electrolyte as the SLIC electrolyte.

Finally, when evaluating the performance of the SLIC electrolyte for a stretchable battery, the performance of the electrolyte under strain is considered. FIG. 3H shows that the SLIC electrolyte can be stretched reversibly between 0 and about 200% with very little change in the ionic conductivity. Overall, the supramolecular design approach of the SLIC electrolyte combined with the judicious choice of electrolyte components makes this polymer electrolyte compelling for use in a stretchable battery. To confirm the desirability of this polymer, comparison of SLIC is made to various other electrolytes. The modulus of resilience (Uᵣ), specified as the area under the reversible portion of the stress strain curve, was chosen as the metric to specify the mechanical properties of the polymer electrolyte. It can be seen from FIG. 3I that the SLIC electrolyte has about an order of magnitude higher modulus of resilience than other most robust electrolytes. Furthermore, the high ionic conductivity value of about 1.2×10⁻⁴ S cm⁻¹ competes with the highest reported ionic conductivities, and is acceptably high for use in lithium-ion battery applications.

### SLIC as a Stretchable Electrode Material

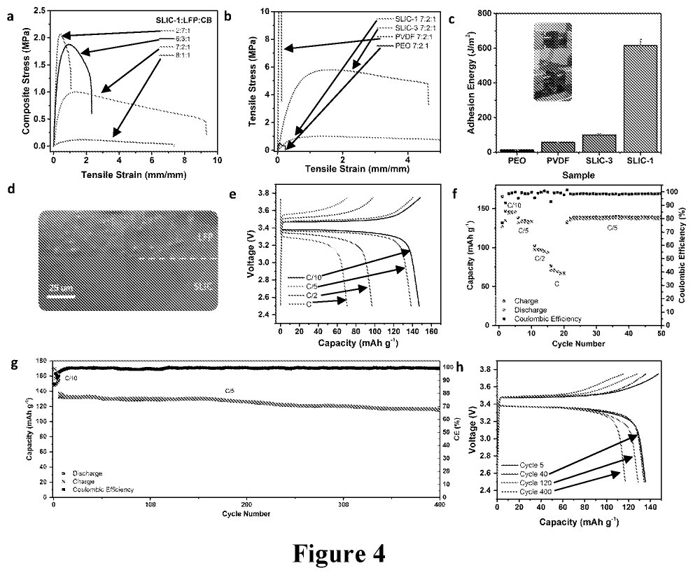

Development of a stretchable electrode material can allow stretchable lithium ion batteries. Other approaches to form stretchable electrode materials either utilize cost-intensive micro/nano scale engineering, or involve coating a small amount of active material onto an elastic support. Intrinsically stretchable electrodes could be fabricated by replacing a binder in electrode materials with a stretchable one. Because SLIC is a polymer with excellent mechanical properties as well as ionic conductivity, it is a candidate for making stretchable composite electrode materials. By using a slurry process, large-scale, free standing electrodes are formed based on mixtures of lithium iron phosphate (LFP), carbon black, and SLIC electrolyte. FIG. 4A shows stress-strain curves of these stretchable composite electrodes as a function of composition. Unless otherwise specified, electrode compositions are given as the weight ratio of polymer:LFP:CB. Generally, as the composition of active material is increased, the stiffness of the composite electrode material increases and the extensibility decreases. A similar trend is observed for electrodes formed with SLIC-3 polymer. Notably, the SLIC based electrodes are able to achieve extensibility of nearly about 100% at a ratio of 2:7:1. At a ratio of 2:1:7, extensibility of about 900% is obtained. FIG. 4B shows stress-strain curves of different electrodes prepared with a ratio of 7:2:1 for a variety of polymers. It can be seen that while the SLIC-3 electrode has a higher modulus and strength, its extensibility is about 450%. The higher extensibility of the SLIC-1 based electrode is attributed the ability of the softer polymer to accommodate more stiffening from the addition of rigid active materials. It is also remarkable how greatly improved the mechanical properties of the SLIC based electrode are compared to either a typical binder material (polyvinylidene difluoride (PVDF)) or a polymer electrolyte material (PEO). The composite electrodes based on these materials cannot be stretched to more than about 20% strain. This result highlights the ability of the ultra-resilient SLIC polymer to form stretchable electrode materials.

One challenge for batteries with solid or gel electrolyte is achieving good interfacial contact and ionic conductivity between the electrode and electrolyte layers. Because of the dynamic nature of the UPy bonds, it is expected that the SLIC electrodes will be able to form strong interfaces with the SLIC electrolyte developed in the previous section. FIG. 4C shows the results of tests of the interfacial adhesion between the SLIC electrolyte with composite electrodes (7:2:1) including SLIC-1, SLIC-3, PEO, and PVDF. Raw data for the adhesion test is shown in Supporting Information. It can be seen that the adhesion energy between the SLIC electrodes and the SLIC electrolyte is much greater than for electrodes made from other polymers. The electrode with SLIC-1 has particularly high adhesion energy, which can be attributed to the SLIC-1 polymer being more flowable than the SLIC-3 polymer, as evidenced by the rheometry in FIG. 1D. This flowability allows the SLIC-1 polymer to form more adhesive hydrogen bonds between the electrode and the electrolyte. A scanning electron microscopy (SEM) image in FIG. 4D shows that the interface between the SLIC-1 based electrode and the SLIC-electrolyte is indeed seamless and continuous.

Battery testing on these stretchable electrode and electrolyte materials was first conducted in coin cells in order to determine their performance in a lithium-ion battery. FIG. 4E shows charge-discharge curves of batteries based the SLIC electrolyte paired with the SLIC-1 composite electrode (7:2:1) and a lithium counter electrode. FIG. 4F shows the corresponding graph of capacity and coulombic efficiency (CE) versus cycle number. The battery with the SLIC based components functions at a rate of up to about 1 C at room temperature, and shows no discernable differences between LFP||Li batteries fabricated with other polymer materials. The cyclic voltammogram of the battery from 2.5 to 3.8V shown in Supporting Information shows that no side reaction or degradation happens in these battery materials over the voltage range of interest. Furthermore, FIGS. 4G and 4H show that the battery can cycle at a rate of C/5 for over 400 cycles with an average coulombic efficiency of about 99.45% and a capacity retention of about 86.8%. Overall, SLIC-based battery components can function with excellent performance in lithium-ion batteries and have no noticeable deleterious effects.

### Stretchable Batteries

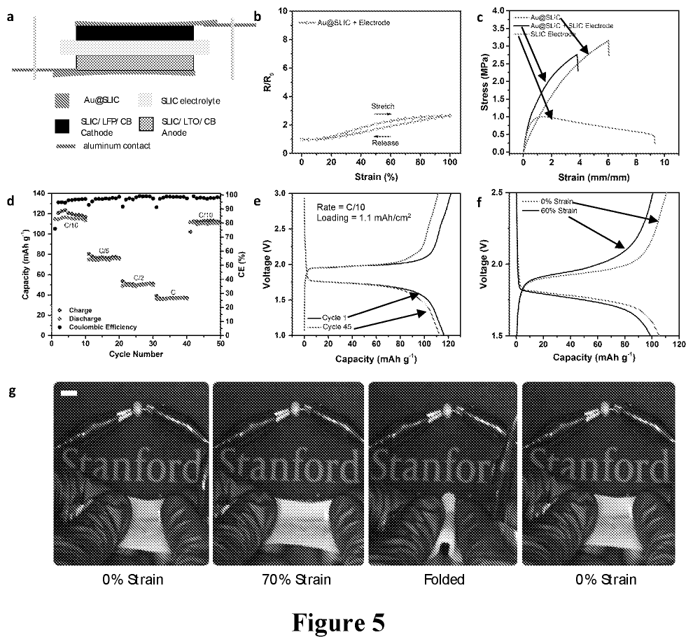

The foregoing demonstrates the ability to use SLIC as a material to fabricate high-performance stretchable electrolyte and electrode materials that can interface well with each other and operate in a half-cell battery configuration. As a final demonstration, it is shown that SLIC can be used to fabricate an all-stretchable battery. FIG. 5A demonstrates a rendering of such a battery, which includes stretchable electrodes, electrolyte, and current collectors based on SLIC polymers. The entire stack is then encapsulated in an elastomer (polydimethylsiloxane (PDMS)). The SLIC-based stretchable current collector is developed. To develop this current collector, a method of microcracked gold was utilized. A thin layer of gold (about 100 nm) was evaporated onto a SLIC substrate. The SLIC electrode slurry was then cast directly onto the gold current collector. The Au@SLIC current collector has a low resistance of about 20 Ωm⁻¹ that does not change dramatically as a function of strain as shown in FIG. 5B. FIG. 5C shows the mechanical properties of the Au@SLIC current collector with and without the SLIC-1 electrode (7:2:1) coating. Even with the electrode coating, the Au@SLIC current collector can be stretched elastically to about 300% of its initial length.

To demonstrate the ability to fabricate full cells based on the stretchable SLIC electrode and electrolyte component, a lithium titanate (LTO) anode was fabricated in the same manner as the LFP electrode. FIG. 5D shows the rate capability of a full cell containing LFP||SLIC-3||LTO. Note that for the full cell, a SLIC-1 electrodes with a ratio of 2:7:1 was used, resulting in a high mass loading of about 1.1 mAh g⁻¹. The full-cell batteries based on the stretchable SLIC components can obtain impressive capacities of nearly about 120 mAh g⁻¹ with coulombic efficiencies reaching over about 99%. FIG. 5E shows the charge-discharge traces of the full cell at a rate of C/10 at cycle 1 and cycle 40, indicating that these stretchable materials last for many cycles in a full cell configuration.

To demonstrate the stretchability of the batteries based on all-SLIC components, the PDMS-encapsulated full cells were operated both unstretched and with about 60% strain applied (FIG. 5F). It can be observed that there is a slight decrease in capacitance and increase in overpotential in response to the about 60% applied strain; however, the effect is minor. The slight decrease in capacity that is observed is likely due to the increase in resistance of the Au@SLIC current collector upon stretching. Finally, as a demonstration, the stretchable SLIC-based battery was charged and used to power a red LED. The red LED remains lit even when the SLIC battery is stretched up to about 70% strain, and folded in half (FIG. 5G). The performance of the SLIC-based battery highlights the ability of the polymer system to create all-stretchable battery components that function as a lithium-ion battery.

### Conclusion

In conclusion, the stretchable lithium ion conductor, SLIC, is a rationally designed, supramolecular polymer than allows the fabrication of high-performance materials for stretchable lithium ion batteries. SLIC's design incorporates orthogonally functional components that provide both high ionic conductivity and excellence resilience. Using this design to overcome the characteristic tradeoff between ionic conductivity and mechanical robustness, fabrication is made of a resilient polymer electrolyte. Additionally, the ultra-robust and ionically conductive nature of the SLIC polymers lends them as excellent binder materials to create stretchable composite electrodes using a slurry casting processes. Combining these stretchable materials allows for the creation of a fully stretchable lithium ion battery based on SLIC materials.

### Materials and Methods

### Synthesis of SLIC Materials

All reagents were purchased from Sigma Aldrich and used without purification unless otherwise specified. NMR spectroscopy was conducted using an Inova 300 MHz spectrometer for ⁷Li NMR. Polymer/salt/additive mixtures were dissolved to a concentration of about 5 wt. % in deuterated chloroform (CDCl₃), and placed into 5 mm borosilicate NMR tubes. CDCl₃ does interfere with solvation of LiTFSI as indicated by the lack of ⁷Li peak in a neat LiTFSI-CDCl₃ mixture. In all instances, samples were prepared and tightly sealed in NMR tubes in the nitrogen environment.

### Physical Characterization of SLIC Materials (DSC, SAXS, SEM, Interfacial Properties)

### Fabrication of SLIC Electrolytes

SLIC polymers were dissolved in tetrahydrofuran (THF) along with an appropriate amount of vacuum-dried LiTFSI and about 14 nm fumed SiO₂. The viscous solution was cast into a Teflon mold, and dried for about 24 hours at room temperature (RT). After drying at RT, the film was further dried for about 24 hours at about 60° C. in a vacuum oven and for about 24 hours in a nitrogen filled glovebox. Resulting films were about 75-200 μm thick. To use, the films were peeled, punched, and plasticized in the confines of the nitrogen glovebox.

### Fabrication of SLIC Electrodes

SLIC polymer and LiTFSI were dissolved in N-methyl-2-pyrrolidone to make a viscous liquid. Active material (LFP/LTO, MTI), and carbon black (Timcal SuperP) were then added in appropriate ratios and mixed using a dual asymmetric centrifugal mixer (FlackTek). Resulting slurries were doctor bladed onto either a Teflon block or current collector and then dried for about 12 hours at RT and about 24 hours at about 70° C. under vacuum. Films were rapidly transferred into a nitrogen-filled glovebox, peeled, and then cut to the appropriate size.

### Electrochemical Characterization

All electrochemical measurements were preformed using a Biologic VSP-300 potentiostat. Temperature controlled experiments utilized an Espec environmental chamber. Electrochemical impedance measurements were conducted by sandwiching polymer films in a symmetric stainless steel (SS||SS) coin cell. A Teflon spacer of about 150 μm was used to ensure no thickness change during the measurement. A frequency range of about 7 MHz to about 100 mHz with a polarization amplitude of about 50 mV was used. Temperature-dependent ionic conductivity was measured from 0 to about 70° C. with equilibration time of about 1 hour at each temperature. Strain-dependent ionic conductivity was conducted by connecting the potentiostat into the glovebox and measuring the impedance between two stainless steel disks clamped onto the stretched polymer film with a fixed amount of pressure. For other electrochemical tests, samples were transferred hermetically to an argon filled glovebox. Electrochemical stability was probed using a Li||SS cell at about 40° C. over a range of 0 to about 4 V with a scan rate of about 0.25 mV/s. Lithium transference number was calculated using a Li||Li symmetric cell at about 40° C. with a polarization of about 50 mV.

Non-stretchable battery tests were conducted using an Arbin battery cycler in 2032 coin cells. An about 2 cm² disk of plasticized electrolyte was placed on top of a freshly scraped about 1 cm² Li disk. An about 1 cm² composite electrode coated onto an aluminum current collector was placed on top of the electrolyte and the stack was sealed in the coin cell.

### Fabrication of Stretchable Batteries

Stretchable current collectors were fabricated by evaporating gold onto a thin (about 20 μm) film of SLIC-3. The evaporation rate was about 8 Å s⁻¹. The strain-dependence of electronic resistance was measured using a Keithly LCR meter with a custom-made stretch station. To make stretchable batteries, the composite electrode slurry was doctor-bladed directly onto the Au@SLIC film. Following drying, Au@SLIC+electrode slurries were transferred into the nitrogen filled glovebox. In the glovebox, the SLIC electrolyte was plasticized, and the components were assembled in the following order: Au@SLIC+LTO||SLIC electrolyte||Au@SLIC+LFP. Aluminum tabs were taped to the edge of the Au@SLIC current collectors, and the entire stack was sandwiched between two slabs of PDMS (EcoFlex DragonSkin 10 Medium) and sealed with a coating of liquid PDMS. Following overnight curing, the battery was transferred out of the glovebox and probed electrochemically. For long-term cycling measurements, stretchable battery components were sealed in coin-cells to reduce the moisture permeability. Typical stretchable batteries had an active material area of about 1 cm². For the LED demonstration, two stretchable batteries with an active material area of about 1 cm² were connected in parallel after sealing in PDMS.

### Supporting Information

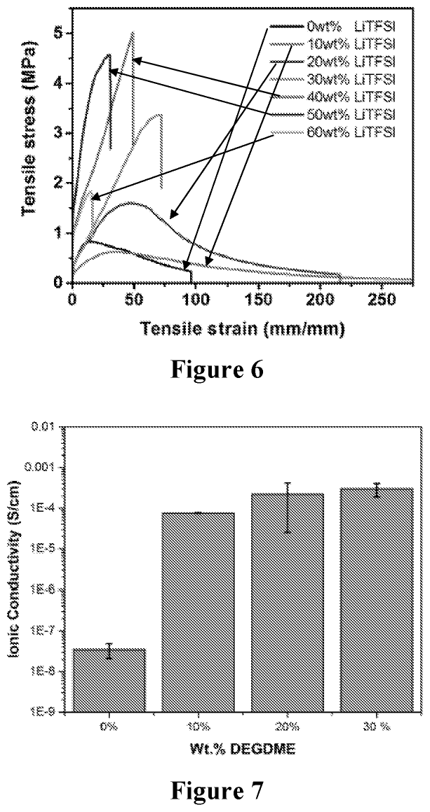

FIG. 6 shows the effect of salt loading on the mechanical properties of the SLIC-1 based electrolyte. Initially, addition of LiTFSI increases the mechanical properties because ionic crosslinking is dominant. This is different than what is observed in SLIC-3, where LiTFSI primarily causes a decrease in the mechanical properties. This difference is because SLIC-1 does not have a substantial number of crosslinks to begin with, so addition of LiTFSI creates additional crosslinks that enhance the strength.

FIG. 7 shows the effect of DEGDME content on ionic conductivity. About 30% DEGDME does not provide significant improvement over about 20% DEGDME.

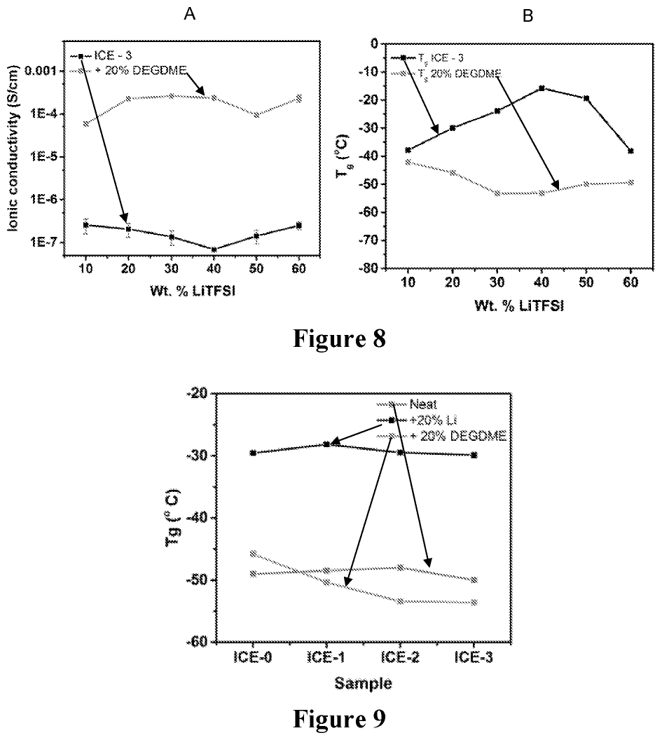

FIG. 8A shows ionic conductivity of SLIC-3 based electrolytes as a function of LiTFSI concentration with and without about 20% DEGDME plasticizer. FIG. 8B shows glass transition temperature of SLIC-3 based electrolytes as a function of LiTFSI concentration with and without about 20% DEGDME plasticizer. For both samples, the measured ionic conductivity correlates with changes in the glass transition temperature. Initially, increased salt causes increased ionic crosslinking up until about 40% LiTFSI, increasing the T_{g} and lowering ionic conductivity. Above about 40% LiTFSI, the plasticizing effect of the TFSI anion becomes dominant, leading to a lowered T_{g} and enhanced ionic conductivity. This correlates well to the sharp drop in mechanical properties that is observed above about 40 wt. % LiTFSI. For the plasticized samples, these effects are less noticeable because the primary mechanism for ionic conductivity is through partially solvated Li⁺.

FIG. 9 shows T_{g} of different SLIC films with about 20% LiTFSI and plasticizer. The addition of about 20% LiTFSI causes a drastic increase in the T_{g}, which is then lowered by the addition of the DEGDME plasticizer. As UPy concentration increases, the T_{g} of the plasticized sample becomes progressively lower. This is potentially caused by interaction of the UPy groups with the DEGDME.

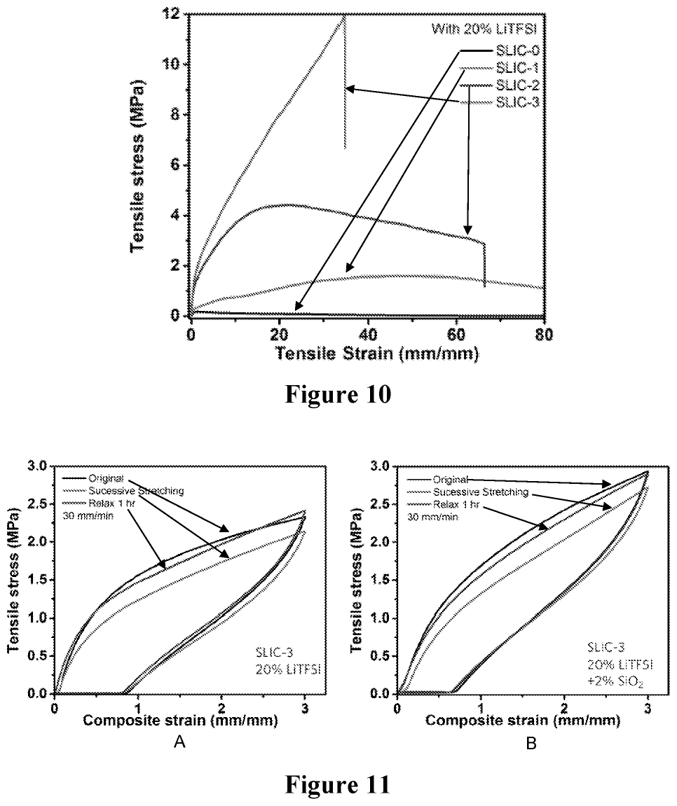

FIG. 10 shows stress-strain measurements of SLIC 0-3 with about 20% LiTFSI.

FIG. 11A shows cyclic stress-strain curves of SLIC-3 with about 20% LiTFSI. The elasticity is retained in the presence of LiTFSI. FIG. 11B shows that including about 2% SiO₂ also has yields better cyclability.

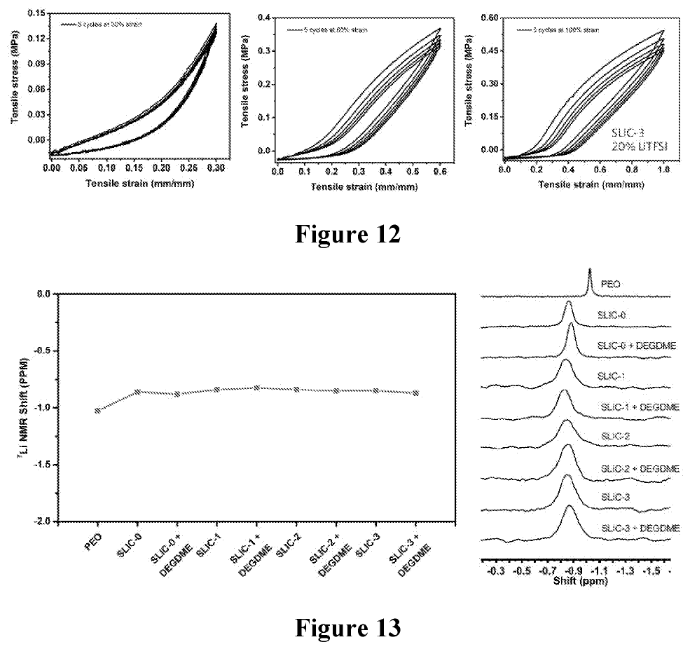

FIG. 12 shows cyclic stress-strain curves of SLIC-3 with about 20% LiTFSI and about 20% DEGDME and about 2% SiO₂. Cycling is performed with 5 cycles each at about 30%, about 60%, and about 1% at a rate of about 30 mm/min.

FIG. 13 shows ⁷Li NMR shift for various SLIC samples and a PEO reference. All samples include about 20 wt. % LiTFSI. Plasticized samples include an additional about 20 wt. % DEGDME. All experiments are carried out in deuterated chloroform, which does not solvate LiTFSI and thus should not affect the coordination environment. The lithium coordination environment does not change drastically for any of the SLIC samples.

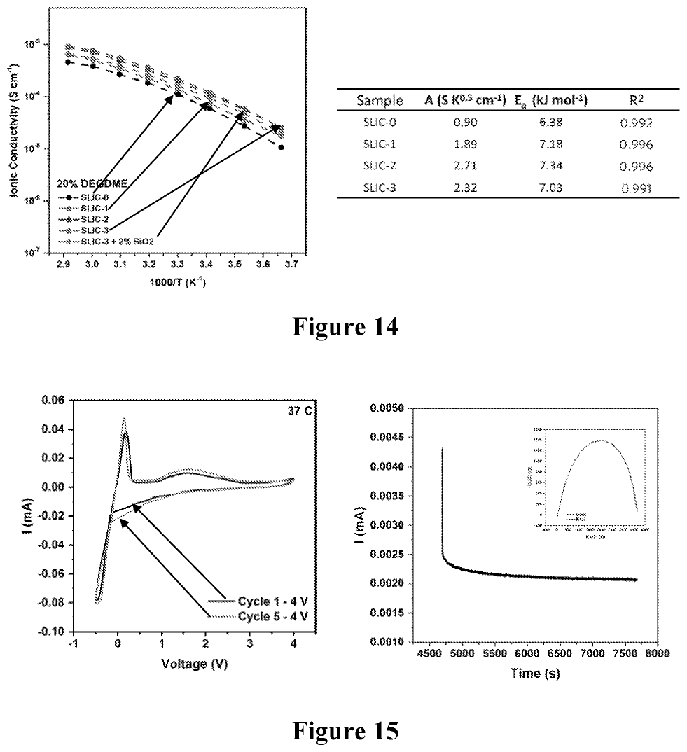

FIG. 14 shows temperature-dependent ionic conductivity of SLIC samples with about 20 wt. % LiTFSI and about 20 wt. % DEGDME. The temperature-dependent ionic conductivity is normalized to the T_{g} of each polymer. It can be seen that the conductivities nearly fall exactly along a master curve. The dashed line serves to guide the eye.

FIG. 15 shows electrochemical stability and transference number measurement of SLIC-3 based electrolyte including about 20% LiTFSI+about 20% DEGDME+about 2% SiO₂. The measurements were carried out at about 37° C., and the measured transference number is about 0.43.

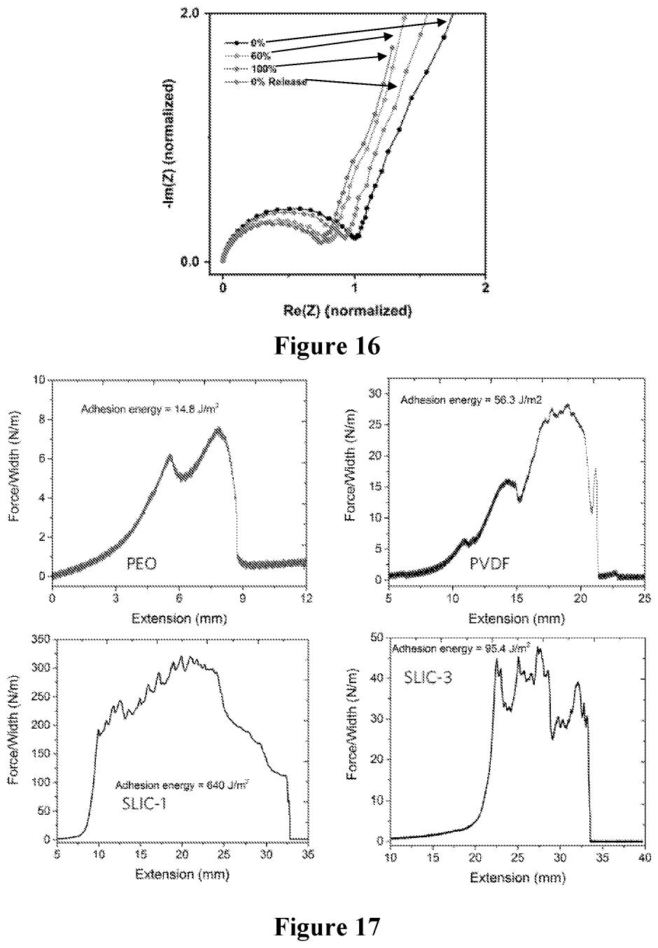

FIG. 16 shows EIS traces as a function of strain for the SLIC-3 based electrolyte, normalized to the resistance of an unstrained sample. The slight decrease in conductivity observed is due to the sample thickness becoming thinner as the stretching increases.

FIG. 17 shows adhesion energy of SLIC-3 and other polymers.

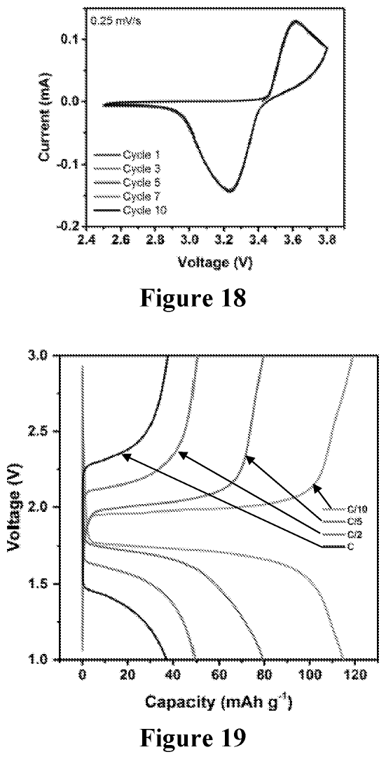

FIG. 18 shows cyclic voltammetry curve of a Li|SLIC|LFP/SLIC/CB electrode at a rate of about 0.25 mV/s. Very little degradation is observed over the progression of the cycles.

FIG. 19 shows charge-discharge curves of SLIC-based LFP||LTO full cell with all stretchable battery components. The mass loading is about 1.1 mAh cm⁻².

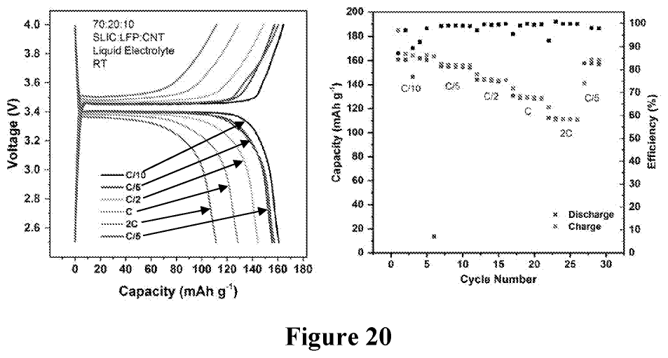

FIG. 20 shows battery performance of SLIC-based electrode in the presence of liquid electrolyte showing high rate-capability and good cycling stability.

As used herein, the singular terms “a,” “an,” and “the” may include plural referents unless the context clearly dictates otherwise. Thus, for example, reference to an object may include multiple objects unless the context clearly dictates otherwise.

As used herein, the terms “substantially,” “substantial,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable characteristics that are substantially the same as those of the non-spherical object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

1. A battery comprising:
an anode;
a cathode; and
an electrolyte disposed between the anode and the cathode, wherein the electrolyte includes a supramolecular polymer including molecules crosslinked through dynamic bonds, and each of the molecules includes an ionically conductive domain.

2. The battery of claim 1, wherein the dynamic bonds include hydrogen bonds, coordination bonds, or electrostatic interactions.

3. The battery of claim 1, wherein each of the molecules includes a hydrogen bonding domain.

4. The battery of claim 3, wherein the hydrogen bonding domain includes an oxygen-containing functional group, a nitrogen-containing functional group, or both.

5. The battery of claim 3, wherein the hydrogen bonding domain includes a 2-ureido-4-pyrimidone moiety.

6. The battery of claim 1, wherein the ionically conductive domain includes a polyalkylene oxide chain.

7. The battery of claim 1, wherein the electrolyte further includes lithium cations dispersed in the supramolecular polymer.

8. The battery of claim 1, wherein the electrolyte further includes fillers dispersed in the supramolecular polymer.

9. The battery of claim 8, wherein the fillers include ceramic fillers.

10. The battery of claim 1, wherein the supramolecular polymer has a glass transition temperature that is no greater than 25° C.

11. The battery of claim 1, wherein the electrolyte has an ionic conductivity of at least 10⁻⁶ S/cm.

12. The battery of claim 1, wherein the electrolyte has an ultimate tensile stress of at least 0.1 MPa.

13. The battery of claim 1, wherein the electrolyte has an extensibility of at least 30%.

14. The battery of claim 1, wherein at least one of the anode or the cathode includes a supramolecular polymer including molecules crosslinked through dynamic bonds, and each of the molecules includes an ionically conductive domain.

15. An electrode comprising:
an active electrode material;
conductive fillers; and
a supramolecular polymer including molecules crosslinked through dynamic bonds, wherein each of the molecules includes an ionically conductive domain, and the active electrode material and the conductive fillers are dispersed in the supramolecular polymer.

16. The electrode of claim 15, wherein the dynamic bonds include hydrogen bonds, coordination bonds, or electrostatic interactions.

17. The electrode of claim 15, wherein each of the molecules includes a hydrogen bonding domain.

18. The electrode of claim 17, wherein the hydrogen bonding domain includes an oxygen-containing functional group, a nitrogen-containing functional group, or both.

19. The electrode of claim 15, wherein the ionically conductive domain includes a polyalkylene oxide chain.

20. A battery comprising the electrode of claim 15.
